(19) United States
(12) Patent Application Publication
(10) Pub. No.: US 2026/0025192 A1
(43) Pub. Date: Jan. 22, 2026

(54) RELAY DEVICE, COMMUNICATION METHOD, AND STORAGE MEDIUM THEREOF

(71) Applicant: DENSO CORPORATION, Kariya-city (JP)

(72) Inventors: Takuto YOSHIDA, Kariya-city (JP); Yasuhiro KOTANI, Kariya-city (JP)

(21) Appl. No.: 19/231,003

(22) Filed: Jun. 6, 2025

(30) Foreign Application Priority Data
Jul. 17, 2024 (JP) 2024-114060

(51) Int. Cl. H04B 7/15; H04W 72/0446; H04W 88/04

(52) U.S. Cl. CPC H04B 7/15; H04W 72/0446; H04W 88/04

(57) ABSTRACT

A relay device is mounted on a vehicle and relays a communication in a communication system of the vehicle. The relay device includes at least one of (i) a circuit and (ii) a processor with a memory storing computer program code executed by the processor, and the at least one of the circuit and the processor may be configured to: receive a frame transmitted from a first communication device; determine whether a transmission time of the frame is assigned to the frame; assign, as the transmission time, a pseudo transmission time, which is determined based on a reception time of the frame at which the frame is received, to the received frame when the transmission time is determined to be not assigned to the frame; and transmit the frame, to which the pseudo transmission time is assigned, to a second communication device.

### CROSS REFERENCE TO RELATED APPLICATION

The present application claims the benefit of priority from Japanese Patent Application No. 2024-114060 filed on Jul. 17, 2024. The entire disclosure of the above application is incorporated herein by reference.

### TECHNICAL FIELD

The present disclosure relates to a relay device, a communication method performed by the relay device, and a storage medium storing a computer program for performing the communication method.

### BACKGROUND

In a known data communication method, a technique is proposed for estimating a generation time of data at which the data is generated by a device.

### SUMMARY

According to an aspect of the present disclosure, a relay device mounted on a vehicle is used in a communication system of the vehicle. The communication system enables a communication between a first communication device and a second communication device. The relay device may include at least one of (i) a circuit and (ii) a processor with a memory storing computer program code executed by the processor, the at least one of the circuit and the processor configured to cause the relay device to: receive a frame transmitted from the first communication device; determine whether a transmission time of the frame is assigned to the frame, the transmission time of the frame indicating a time when the frame is transmitted by the first communication device; assign, as the transmission time, a pseudo transmission time, which is determined based on a reception time of the frame at which the frame is received, to the received frame when the transmission time is determined to be not assigned to the frame; and transmit the frame, to which the pseudo transmission time is assigned, to the second communication device.

### BRIEF DESCRIPTION OF DRAWINGS

Features of the present disclosure will become apparent from the following detailed description made with reference to the accompanying drawings. In the drawings:

FIG. 1 is a schematic diagram showing a configuration example of a communication system;

FIG. 2 is a block diagram showing a configuration of a communication system;

FIG. 3 is a flowchart showing a part of a transmission time assignment process; and

FIG. 4 is a flowchart showing remaining part of the transmission time assignment process.

### DETAILED DESCRIPTION

Conventionally, a time stamping device estimates, in advance, a delay time based on a duration required from transmission of an echo request packet of Internet Control Message Protocol (ICMP) to a device to reception of a response message from the device. When the time stamping device receives data from the device, the time stamping device calculates a generation time of the data, which is generated by the device, with consideration of the delay time estimated in advance. The time stamping device adds, to the data, the calculated generation time of the data, and then transfers the data to which the time information is added.

After performing detailed study by the inventors of the present disclosure, another configuration is found for adding the generation time of data to a frame in a simple manner, that is, another configuration is found for adding a transmission time of frame to the frame in a simple manner.

According to an aspect of the present disclosure, a relay device mounted on a vehicle is used in a communication system of the vehicle. The communication system enables a communication between a first communication device and a second communication device. The relay device includes at least one of (i) a circuit and (ii) a processor with a memory storing computer program code executed by the processor, and the at least one of the circuit and the processor is configured to cause the relay device to: receive a frame transmitted from the first communication device; determine whether a transmission time of the frame is assigned to the frame, the transmission time of the frame indicating a time when the frame is transmitted by the first communication device; assign, as the transmission time, a pseudo transmission time, which is determined based on a reception time of the frame at which the frame is received, to the received frame when the transmission time is determined to be not assigned to the frame; and transmit the frame, to which the pseudo transmission time is assigned, to the second communication device.

According to the above configuration, the relay device can easily assign the transmission time to the frame transmitted by the first communication device that does not have a function of assigning the transmission time to the frame. Thus, the transmission time can be easily added to the frame when the frame is received by the relay device.

The following will describe exemplary embodiments of the present disclosure with reference to the drawings.

### (1. Embodiment)

### (1-1. Configuration)

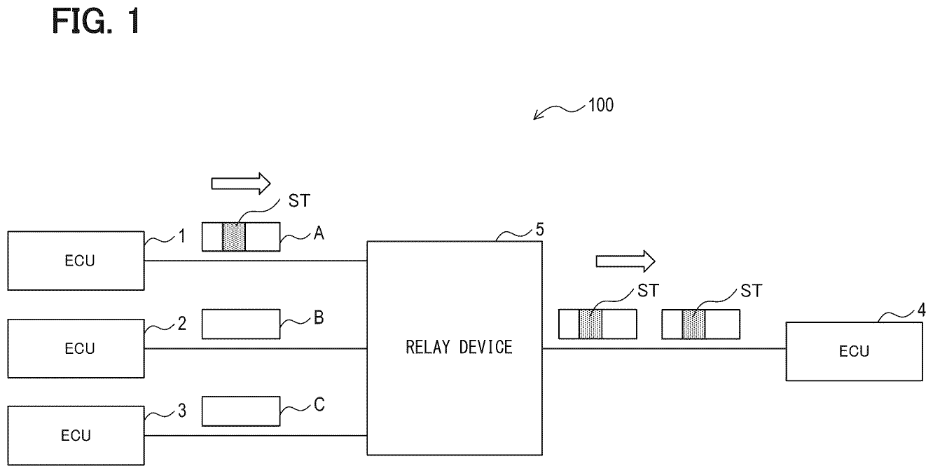

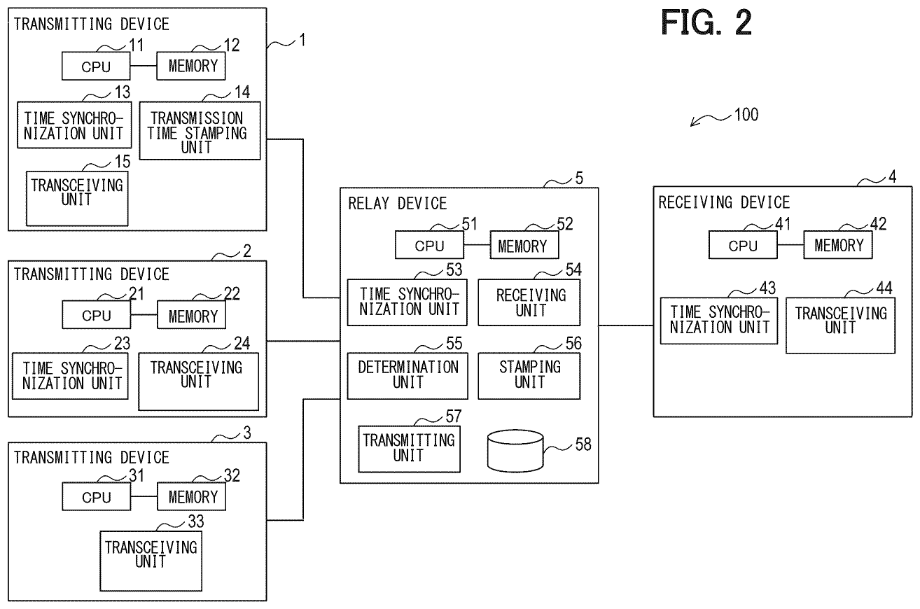

As shown in FIG. 1 and FIG. 2, a communication system 100 according to the present embodiment configures an Ethernet (registered trademark) network system mounted on a vehicle, such as a passenger car. The network is not limited to Ethernet, and may be any network using a different communication protocol. The optional communication protocol may be LIN, CAN, FlexRay, MOST, or CXPI. LIN is an abbreviation for Local Interconnect Network. CAN is an abbreviation for Controller Area Network. MOST is an abbreviation for Media Oriented Systems Transport. CXPI is an abbreviation for Clock Extension Peripheral Interface.

The communication system 100 includes multiple electronic control units (ECU), that is, ECU 1, ECU 2, ECU 3, and ECU 4 (hereinafter referred to as ECU 1 to ECU 4), and a relay device 5. Each of the ECU 1 to ECU 4 is connected to the relay device 5 via a communication line. ECU is an abbreviation for Electronic Control Unit.

The ECU 1 to ECU 4 each is connected to sensors, actuators, etc. (not shown). For example, each of the ECU 1 to ECU 4 transmits data (for example, frames) obtained from a sensor to another ECU via the relay device 5. For example, each of the ECU 1 to ECU 4 operates an actuator based on data received from another ECU via the relay device 5. Each of the ECU 1 to ECU 4 has a function of transmitting and receiving data to and from the relay device 5 connected thereto.

In the communication system 100, the ECU 1 to ECU 4 are connected to one another so as to be able to communicate with one another via the relay device 5. The ECU 1 to ECU 4 are configured to be able to transmit and receive data to and from one another via the relay device 5. The present embodiment will be described under a situation in which the ECU 1 to ECU 3 function as transmitting devices that transmit data, and the ECU 4 functions as a receiving device that receives data. For example, in the configuration shown in FIG. 1, the ECU 1 transmits data A, the ECU2 transmits data B, and the ECU3 transmits data C. The ECU 1 to ECU 3 may be referred to as transmitting devices, and the ECU 4 may be referred to as a receiving device. The ECU 1 to ECU 4 and the relay device 5 may be referred to as nodes.

### (1-1-1. Transmitting Device)

As shown in FIG. 2, the ECU 1 includes a CPU 11 and a memory 12. The memory 12 stores programs to be executed by the CPU 11 to perform predetermined functions.

The ECU 1 implements functions of the following units when the CPU 11 executes the programs stored in the memory 12. The ECU 1 has the functions of a time synchronization unit 13, a transmission time stamping unit 14, and a transceiving unit 15.

The time synchronization unit 13 is configured to synchronize the time with another node that includes a time synchronization unit. The time synchronization may be performed according to IEEE802.1AS. Specifically, the local time used in one node is synchronized with the global time used in another node. IEEE stands for Institute of Electrical and Electronics Engineers.

The transmission time stamping unit 14 is configured to assign a transmission time ST of a frame to a header of the frame. More precisely, the transmission time ST of frame is a time immediately before the transceiving unit 15 transmits the frame, or a time when the frame is generated. The frame header may use a format defined under IEEE 1722.

The transceiving unit 15 is configured to transmit and receive frames. In the present embodiment, the transceiving unit 15 of ECU 1 transmits frames to the ECU 4 via the relay device 5.

The ECU 2 includes a CPU 21 and a memory 22. The memory 22 stores programs to be executed by the CPU 21 to perform predetermined functions.

The ECU 2 implements functions of the following units when the CPU 21 executes the programs stored in the memory 22. The ECU 2 has the functions of a time synchronization unit 23 and a transceiving unit 24. The ECU 2 differs from the ECU 1 in that the ECU 2 does not include a transmission time stamping unit.

The time synchronization unit 23 is configured to synchronize the time with another node that includes a time synchronization unit.

The transceiving unit 24 is configured to transmit and receive frames. In the present embodiment, the transceiving unit 24 transmits frames to the ECU 4 via the relay device 5. Since the ECU 2 does not have a transmission time stamping unit, in the frame transmitted by the ECU 2, a transmission time ST is not assigned to the header of the frame.

The ECU 3 includes a CPU 31 and a memory 32. The memory 32 stores programs to be executed by the CPU 31 for performing predetermined functions.

The ECU 3 implements functions of the following units when the CPU 31 executes the programs stored in the memory 32. The ECU 3 has the function of a transceiving unit 33. The ECU 3 differs from the ECU 1 in that the ECU 3 does not include a time synchronization unit and a transmission time stamping unit.

The transceiving unit 33 is configured to transmit and receive frames. In the present embodiment, the transceiving unit 33 transmits frames to the ECU 4 via the relay device 5. Since the ECU 3 does not have a time synchronization unit, the ECU 3 cannot synchronize the time with another node that has a time synchronization unit. Since the ECU 3 does not have a transmission time stamping unit, in the frame transmitted by the ECU 3, a transmission time ST is not assigned to the header of the frame.

### (1-1-2. Receiving Device)

The ECU 4 includes a CPU 41 and a memory 42. The memory 42 stores programs to be executed by the CPU 41 to perform predetermined functions.

The ECU 4 implements functions of the following units when the CPU 41 executes the programs stored in the memory 42. The ECU 4 has the functions of a time synchronization unit 43 and a transceiving unit 44.

The time synchronization unit 43 is configured to synchronize the time with another node that has a time synchronization unit.

The transceiving unit 44 is configured to transmit and receive frames. In the present embodiment, the transceiving unit 44 receives frames from the ECU 1 to ECU 3 via the relay device 5.

### (1-1-3. Relay Device)

The relay device 5 has a relay function of transferring a frame received from an ECU, which is connected to the relay device, to another ECU, which is connected to the relay device. In the present embodiment, the relay device 5 relays communications among the ECU 1 to ECU 4. The relay device 5 may also have a function of a gateway device. By having the function of a gateway device, the relay device 5 can relay frames (data) between different communication protocols.

The relay device 5 is implemented by a microcomputer including a CPU 51 and a memory 52. The memory 52 stores programs to be executed by the CPU 51 to perform predetermined functions. In the memory 52, a forwarding table (not shown) is stored. The forwarding table is a data table that indicates forwarding paths. Specifically, the forwarding table is a data table that associates a MAC address of frame transmission source with a MAC address of forwarding destination.

The relay device 5 implements functions of the following units when the CPU 51 executes the programs stored in the memory 52. The relay device 5 has functions of a time synchronization unit 53, a receiving unit 54, a determination unit 55, a stamping unit 56, a transmitting unit 57, and a list management unit 58.

The time synchronization unit 53 is configured to synchronize the time with another node that includes a time synchronization unit.

The receiving unit 54 is configured to receive frames transmitted from the transmitting device.

The determination unit 55 is configured to determine whether the transmission time ST, which indicates the time when the transmitting device transmits the frame, is added to the frame. Specifically, the determination unit 55 determines whether the transmission time ST is added to the header of the frame received by the receiving unit 54.

The stamping unit 56 is configured to assign a pseudo transmission time, which is set based on the reception time at which the receiving unit 54 receives the frame, to the frame as the transmission time ST in response to the determination unit 55 determining that the transmission time ST is not assigned to the frame. The following will describe a transmission time assignment process execute by the determination unit 55 and the stamping unit 56 in details.

The transmitting unit 57 is configured to forward a frame based on the forwarding table. The transmitting unit 57 is configured to transmit, to the receiving device, the frame received by the receiving unit 54 as is or the frame to which the pseudo transmission time is assigned by the stamping unit 56.

The transmitting unit 57 transmits, to the receiving device, four patterns of frames, that is, a first frame, a second frame, a third frame, and a fourth frame. The first frame is a frame to which the transmission time ST is originally assigned by the transmitting device. The second frame is a frame to which a pseudo transmission time is assigned as the transmission time ST. Herein, the pseudo transmission time is set with consideration of a propagation delay, which will be described later. The third frame is a frame to which a pseudo transmission time is assigned as the transmission time ST. Herein, the pseudo transmission time is set as a reception time of the frame by the receiving unit 54. The fourth frame is a frame to which no transmission time ST is assigned by the transmitting device nor no pseudo transmission time is assigned as the transmission time ST by the relay device 5 neither. The first and fourth frames are transferred as is after being transmitted from the transmitting device. The second and third frames are frames to which the relay device 5 assigns the pseudo transmission time as the transmission time ST.

The list management unit 58 is a storage device or a database that stores a first record list and a second record list, which will be described later.

Each of the ECU 1 to ECU 4 and the relay device 5 may be implemented by one microcomputer or multiple microcomputers.

The method of performing the function of each unit included in the ECU 1 to ECU 4 and the relay device 5 is not limited in software manner. Partial or all of the functions may be implemented using one or more hardware circuits in hardware manner. For example, when the above-described functions are implemented by an electronic circuit, which is a hardware circuit, the electronic circuit may be implemented by a digital circuit, an analog circuit, or a combination of digital circuit and analog circuit.

### (1-2. Process)

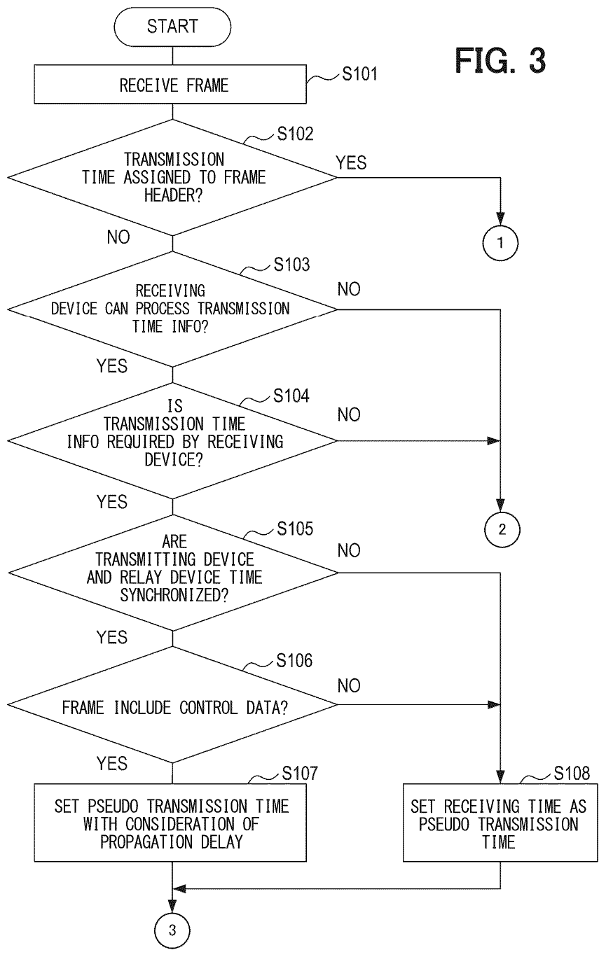

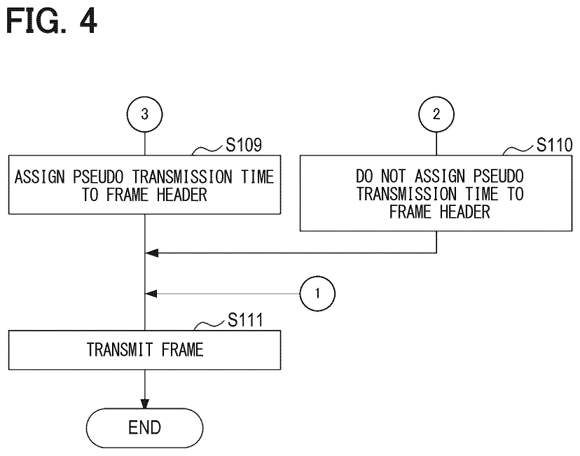

The following will describe the transmission time assignment process executed by the relay device 5 with reference to the flowcharts shown in FIG. 3 and FIG. 4. The transmission time assignment process is repeatedly executed while the ignition switch is on state.

In S101, the receiving unit 54 of the relay device 5 receives a frame from the transmitting device.

In S102, the determination unit 55 of the relay device 5 determines whether a transmission time ST is assigned to the header of the frame. Specifically, the determination unit 55 determines whether a timestamp is set in the header of the frame.

In response to the determination unit 55 determining, in S102, that the transmission time ST is not assigned to the header of the frame, the process proceeds to S103. In response to the determination unit 55 determining, in S102, that the transmission time ST is assigned to the header of the frame, the process proceeds to S111. In S111, the transmitting unit 57 of the relay device 5 transmits, to the receiving device, the frame transmitted from the transmitting device in S101 without performing stamping to the frame. That is, the transmitting unit 57 transmits the first frame to the receiving device.

In S103, the relay device 5 determines whether the receiving device has a function of processing the information related to the transmission time ST assigned to the frame. Specifically, the relay device 5 determines, by referring to the first record list stored in the list management unit 58, whether the receiving device is capable of processing the information related to the transmission time ST. The first record list is a list that records whether a destination receiving device has a function of processing the information related to the transmission time ST assigned to the frame. When the first record list indicates that the receiving device is capable of processing the information related to the transmission time ST, the relay device 5 determines that the receiving device is capable of processing the information related to the transmission time ST. For example, the function of processing information related to the transmission time ST is a function of reading a timestamp of the transmission time ST.

When the relay device 5 determines in S103 that the receiving device is capable of processing the information related to the transmission time ST, the process proceeds to S104. When the relay device 5 determines in S103 that the receiving device cannot process the information related to the transmission time ST, the process proceeds to S110. In S110, the relay device 5 does not assign the pseudo transmission time as the transmission time ST to the frame, and proceeds to S111. In S111, the transmitting unit 57 transmits, to the receiving device, the frame, which is transmitted from the transmitting device and is received by the relay device in S101, without performing stamping to the frame. That is, the transmitting unit 57 transmits the fourth frame to the receiving device.

In S104, the relay device 5 determines whether the receiving device requires information related to the transmission time ST. Specifically, the relay device 5 determines, by referring to the second record list stored in the list management unit 58, whether the receiving device requires information related to the transmission time ST. The second record list is a list that indicates whether the receiving device, which corresponds to the forward destination, requires information related to the transmission time ST. When the second record list records that the receiving device requires information related to the transmission time ST, the relay device 5 determines that the receiving device requires information related to the transmission time ST. For example, when it is necessary to process data in chronological order by reading the timestamp of the transmission time ST in the receiving device, the second record list may record that the information related to the transmission time ST is required by the receiving device.

When the relay device 5 determines in S104 that the receiving device requires the information related to the transmission time ST, the process proceeds to S105. When the relay device 5 determines in S104 that the receiving device does not require the information related to the transmission time ST, the process proceeds to S110. In S110, the relay device 5 does not assign the pseudo transmission time as the transmission time ST to the frame, and proceeds to S111. In S111, the transmitting unit 57 transmits, to the receiving device, the frame, which is transmitted from the transmitting device and is received by the relay device in S101, without performing stamping to the frame. That is, the transmitting unit 57 transmits the fourth frame to the receiving device.

In S105, the relay device 5 determines whether the transmitting device and the relay device 5 are synchronized in time. Specifically, the relay device 5 determines whether the transmitting device is a transmitting device that performs communication with the relay device 5 for time synchronization purpose. When a transmitting device performs communication with the relay device 5 for time synchronization purpose, the relay device 5 determines that the transmitting device and the relay device 5 are synchronized in time. The relay device 5 may store, in advance, a list of transmitting devices that directly or indirectly refer to the global time for time synchronization, and may determine whether the transmitting device and the relay device 5 are synchronized in time by referring to this list.

When the relay device 5 determines in S105 that the transmitting device and the relay device 5 are synchronized in time, the process proceeds to S106. When the relay device 5 determines in S105 that the time synchronization between the transmitting device and the relay device 5 is not established, the process proceeds to S108.

In S106, the relay device 5 determines whether the frame includes control data. The control data is data corresponding to an operation of vehicle, such as making a turn, moving, or stop. For example, the control data is used by a powertrain ECU, an ECU that controls automated driving function or driving assistance function, or the like. The control data may be used in combination with other control data in the receiving device. Multiple pieces of control data may be used in a sensor fusion manner. In such a case, the multiple pieces of control data may be sampled at predetermined cycle as frequent as possible. That is, the control data is required to be linked to a more accurate transmission time ST. Data other than the control data includes data corresponding to multimedia functions such as audio, and data corresponding to comfort functions such as air conditioning.

When the relay device 5 determines in S106 that the frame includes the control data, the process proceeds to S107. When the relay device 5 determines in S106 that the frame does not include the control data, the process proceeds to S108.

In S107, the relay device 5 sets the pseudo transmission time taking into consideration of the propagation delay. When the transmitting device and the relay device 5 are synchronized in time, the relay device 5 records the propagation delay in advance. As an example, the relay device 5 records, as the propagation delay, the difference between a timestamp indicating the transmission time ST of a frame transmitted from a transmitting device and a timestamp indicating the reception time when the relay device 5 receives the frame.

The relay device 5 determines the pseudo transmission time by subtracting the delay time, that is, the propagation delay from the reception time of frame. The propagation delay is a duration by which a signal is delayed on the communication path from the transmitting device to the relay device 5 When the data is required to be linked to a more accurate transmission time ST, such as control data, the transmission time that takes into account the propagation delay time is considered to be closer to the actual transmission time ST than the reception time, which is the time when the receiving unit 54 of the relay device 5 receives the frame transmitted from the transmitting device. Thus, the transmission time that takes into account the propagation delay time is used as the pseudo transmission time.

In S108, the relay device 5 sets the reception time, which is the time when the receiving unit 54 actually receives the frame transmitted from the transmitting device, as the pseudo transmission time. When the transmitting device and relay device 5 are not synchronized in time and the propagation delay cannot be measured, or when the data can be used without strictly calculating the transmission time ST taking into account the propagation delay, the reception time is used as the pseudo transmission time.

In S109, the stamping unit 56 of the relay device 5 assigns the pseudo transmission time to the header of frame. Specifically, the stamping unit 56 assigns the pseudo transmission time calculated in S107 or the pseudo transmission time calculated S108 as the transmission time ST of the frame. The stamping unit 56 generates a second frame to which the pseudo transmission time calculated in S107 is assigned, or generates a third frame to which the pseudo transmission time calculated in S108 is assigned.

In S111, the transmitting unit 57 transmits the frame to the receiving device. The transmitting unit 57 transmits any one of the first to fourth frames to the receiving device.

### (1-3. Effects)

According to the embodiment described in detail above, the following effects can be obtained.

(1a) In the above embodiment, when the relay device 5 determines that a frame has not been assigned with a transmission time ST, the relay device 5 assigns a pseudo transmission time to the frame as the transmission time ST. According to such a configuration, the relay device 5 can easily assign the transmission time ST to a frame transmitted from the transmitting device that does not have a function of assigning the transmission time ST to the header of frame. Thus, the receiving device can process the frame with consideration of the information related to the transmission time ST, thereby ensuring consistency with other received frames easily.

(1b) In the above embodiment, when the relay device 5 determines that the transmitting device and the relay device 5 are not synchronized in time or when the relay device 5 determines that the frame does not include control data, the relay device 5 sets the reception time, which is the time when the receiving unit 54 of the relay device 5 actually receives the frame transmitted from the transmitting device, as the pseudo transmission time. According to this configuration, the relay device 5 can easily assign the transmission time ST.

In an in-vehicle network, a communication line connecting the transmitting device with the relay device 5 is relatively short. Even though the reception time is set as the pseudo transmission time, the set pseudo transmission time is less likely to deviate significantly from the actual transmission time ST. When the transmitting device and relay device 5 are not synchronized in time and the propagation delay cannot be measured, or when the control data does not require strictly calculated transmission time ST by considering the propagation delay time, the reception time may be used as the pseudo transmission time. With this configuration, it is possible to more simply assign the transmission time ST. As the above-described ECU 3, the transmitting device may be an ECU that does not include a time synchronization unit or a transmission time stamping unit. In particular, when the transmitting device and the relay device 5 communicate directly without going through another relay device 5 therebetween, by using the reception time as the pseudo transmission time, there is less deviation from the actual transmission time ST.

(1c) In the above embodiment, when the relay device 5 determines that the transmitting device and the relay device 5 are synchronized in time and that the frame includes the control data, the relay device 5 determines that the pseudo transmission time by subtracting the delay time from the reception time.

For example, a transmitting device may have a time synchronization function but does not have a function of adding a transmission time ST to a frame. As the above-described ECU 2, the transmitting device may be an ECU that includes a time synchronization unit 23, but does not include a transmission time stamping unit. As an example, a legacy ECU that does not have the function of assigning the transmission time ST to a frame, or an inexpensive ECU that does not have the function of assigning the transmission time ST for cost saving purpose may be considered. According to the above-described configuration, the relay device 5 can easily assign a transmission time ST to a frame transmitted by such an ECU.

The control data is required to be linked to a more accurate transmission time ST in some cases. The relay device 5 uses a time that takes propagation delay into account as the pseudo transmission time. Thus, the relay device 5 can easily assign a more accurate transmission time ST to the frame. Therefore, the control data can be used for a process that requires real-time performance or a process that requires high response speed.

(1d) In the above embodiment, when the relay device 5 determines that the receiving device does not require information about the transmission time ST, the relay device 5 does not assign a pseudo transmission time to the frame. With this configuration, the relay device 5 can prevent unnecessary information from being transmitted to the receiving device.

(1e) In the above embodiment, when the relay device 5 determines that the receiving device does not have the function to process the information related to the transmission time ST assigned to the frame, the relay device 5 does not assign a pseudo transmission time to the frame. With this configuration, the relay device 5 can prevent unnecessary information from being transmitted to the receiving device.

### (1-4. Correspondence)

In the above embodiment, each of the ECU 1 to ECU 3 corresponds to a first communication device, and the ECU 4 corresponds to a second communication device.

### (2. Other Embodiments)

Although the embodiments of the present disclosure have been described above, it is needless to say that the present disclosure is not limited to the above-described embodiments, and can be modified in various forms.

(2a) In the above embodiment, in response to the relay device 5 determining in S106 that the frame does not include the control data, the relay device 5 sets the reception time as the pseudo transmission time in S108. In S106, in response to the relay device 5 determining that the frame does not include the control data, the process may proceed to S107 and determine the pseudo transmission time by subtracting the delay time from the reception time.

(2b) In the above embodiment, the communication system 100 includes one relay device 5. In another example, the communication system 100 may include multiple relay devices. A relay device may be further provided between the transmitting device and the relay device 5, and a relay device may be further provided between the relay device 5 and the receiving device. When the forwarding table is recorded in each relay device and each relay device is equipped with a time synchronization unit, each relay device may assign a pseudo transmission time to a frame transmitted from a transmitting device.

(2c) In the above embodiment, the ECU 1 to ECU 3 are connected in parallel with respect to the relay device 5. The manner in which the transmitting devices are connected to the relay device 5 is not limited to this example. In another example, the transmitting device may be connected to the relay device 5 in a multi-drop connection.

(2d) Each of the devices and the method described in the present disclosure (that is, ECU 1 to ECU 4, relay device 5) and the techniques used by each of the devices may be implemented by a special-purpose computer provided by configuring a processor and memory programmed to perform one or more functions embodied in a computer program. Alternatively, each of the devices and the method used by each of devices described in the present disclosure may be implemented by a special purpose computer provided by configuring a processor with one or more special purpose hardware logic circuits. Alternatively, each of the devices and the method used by each of devices described in the present disclosure may be implemented by one or more special-purpose computer configured by a combination of a processor and memory programmed to perform one or more functions and a processor configured by one or more hardware logic circuits. The computer program may be stored in a computer-readable non-transitory tangible storage medium as instructions to be executed by the computer. A method for implementing the functions of each functional unit included in each device does not necessarily include software, and all of the functions may be implemented by using one or multiple hardware circuits.

(2e) The multiple functions of one component in the above embodiments may be implemented by multiple components, or a function of one component may be implemented by multiple components. Multiple functions of multiple configuration elements in the above embodiments may be implemented by one configuration element, or one function implemented by multiple configuration elements may be implemented by one configuration element. In the above embodiment, a part of the configuration may be properly omitted. At least a part of the configuration of the above embodiment may be added to or substituted for the configuration of the other embodiment.

(2f) In addition to the communication system 100 described above, the present disclosure can also be implemented in various forms, such as each device included in the communication system 100, a program for causing a computer to function as each device included in the communication system 100, a non-transitory tangible storage medium such as a semiconductor memory in which the above-described program is stored, and a communication method thereof.

What is claimed is:

1. A relay device mounted on a vehicle and used in a communication system of the vehicle, the communication system enabling a communication between a first communication device and a second communication device, the relay device comprising:
at least one of (i) a circuit and (ii) a processor with a memory storing computer program code executed by the processor, the at least one of the circuit and the processor configured to cause the relay device to:
receive a frame transmitted from the first communication device;
determine whether a transmission time of the frame is assigned to the frame, the transmission time of the frame indicating a time when the frame is transmitted by the first communication device;
assign, as the transmission time, a pseudo transmission time, which is determined based on a reception time of the frame at which the frame is received, to the received frame when the transmission time is determined to be not assigned to the frame; and
transmit the frame, to which the pseudo transmission time is assigned, to the second communication device.

2. The relay device according to claim 1, wherein
the at least one of the circuit and the processor is configured to set the reception time of the frame as the pseudo transmission time.

3. The relay device according to claim 1, wherein
the at least one of the circuit and the processor is configured to set, as the pseudo transmission time, a time obtained by subtracting a delay time from the reception time of the frame, and
the delay time is a duration by which a signal is delayed on a communication path from the first communication device to the relay device.

4. The relay device according to claim 1, wherein
the at least one of the circuit and the processor is configured to:
determine whether the second communication device requires information related to the transmission time by referring to a list in which information indicating whether the second communication device requires the information related to the transmission time is recorded in advance; and
in response to determining that the second communication device does not require the information related to the transmission time, transmit the received frame to the second communication device without assigning the pseudo transmission time to the frame as the transmission time.

5. The relay device according to claim 1, wherein
the at least one of the circuit and the processor is configured to:
determine whether the second communication device has a function of processing information related to the transmission time assigned to the frame by referring to a list in which information indicating whether the second communication device has the function of processing the information related to the transmission time assigned to the frame is recorded in advance; and
in response to determining that the second communication device does not have the function of processing the information related to the transmission time assigned to the frame, transmit the received frame to the second communication device without assigning the pseudo transmission time to the frame as the transmission time.

6. A communication method for controlling a relay device, the relay device being mounted on a vehicle and relaying a communication in a communication system of the vehicle, the communication system enabling a communication between a first communication device and a second communication device, the communication method comprising:
receiving, by the relay device, a frame transmitted from the first communication device;
determining, in the relay device, whether a transmission time of the frame is assigned to the frame, the transmission time of the frame indicating a time when the frame is transmitted by the first communication device;
assigning, by the relay device, a pseudo transmission time, which is determined based on a reception time of the frame at which the frame is received, as the transmission time to the received frame when the transmission time is determined to be not assigned to the frame; and
transmitting, by the relay device, the frame, to which the pseudo transmission time is assigned, to the second communication device.

7. A non-transitory computer readable storage medium storing a program comprising instructions configured to, when executed by at least one processor, cause the at least one processor to:
receive a frame transmitted from the first communication device;
determine whether a transmission time of the frame is assigned to the frame, the transmission time of the frame indicating a time when the frame is transmitted by the first communication device;
assign a pseudo transmission time, which is determined based on a reception time of the frame at which the frame is received, as the transmission time to the received frame when the transmission time is determined to be not assigned to the frame; and
transmit the frame, to which the pseudo transmission time is assigned, to the second communication device.
